(19) United States
(12) Patent Application Publication
(10) Pub. No.: US 2015/0172254 A1
(43) Pub. Date: Jun. 18, 2015

(54) System and Method For Operating a Social Networking Site on the Internet

(71) Applicant: Wesley Edouard, Vancouver, WA (US)

(72) Inventor: Wesley Edouard, Vancouver, WA (US)

(21) Appl. No.: 14/561,225

(22) Filed: Dec. 5, 2014

Related U.S. Application Data
(60) Provisional application No. 61/916,786, filed on Dec. 16, 2013.

(51) Int. Cl. H04L 29/06; H04L 12/58

(52) U.S. Cl. CPC H04L 63/0421; H04L 51/32

(57) ABSTRACT

A system for operating a social networking site on the internet. The system comprises a server machine in communication with the internet and a social site module operating on the server machine. The module comprises code to create a Real ID for the first user and code to create an identity variable for the first user set to the Real ID. The module further comprises code to create a Virtual ID for the first user and a fourth set of code to display a web page on the first communication device of the first user. The web page comprises a change identity button and a post by the second user. The module further comprises code to change the identity variable of the first user from Real ID to Virtual ID upon activation of the change identity button and code to post a comment on the post by the second user displaying the Virtual ID of the first user.

### CROSS-REFERENCE TO RELATED APPLICATIONS

This application claims priority to U.S. Provisional Application Ser. No. 61/916,786 filed on Dec. 16, 2013, now pending, which is hereby incorporated into this specification by reference in its entirety.

### BACKGROUND OF THE INVENTION

Social networking sites on the internet have exploded and are a significant way of communication between people or groups of people. To promote free and open exchange in various situations, some people may wish to post a message in an anonymous manner where the person's real ID is hidden. No conventional social networking site exists that allows a person the option of posting a message in an open manner where the public can view the person's real ID or in an anonymous manner where the person's real ID is not visible.

### SUMMARY OF THE INVENTION

The present invention a system for operating a social networking site on the Internet accessible by first and second users having first and second communication devices, respectively. The system comprises a server machine in communication with the internet and a social site module stored and operating on the server machine. The social site module comprises a first set of code configured to create a Real ID for the first user and a second set of code configured to create an identity variable for the first user set to the Real ID. The social site module further comprises a third set of code configured to create a Virtual ID for the first user and a fourth set of code configured to display a web page on the first communication device of the first user. The web page comprises a change identity mode button and a post by the second user. The social site module further comprises a fifth set of code configured to change the identity variable of the first user from Real ID to Virtual ID upon activation of the change identity mode button and a sixth set of code configured to post a comment by the first user on the post by the second user displaying the Virtual ID of the first user.

### BRIEF DESCRIPTION OF THE DRAWINGS

The following description of the invention will be more fully understood with reference to the accompanying drawings in which:

FIG. 1 is a high level block diagram showing the architecture of a system for operating a social networking site on the Internet according to the present invention;

FIG. 2 is a high level flow chart showing the operation of a social site module according to the present invention;

FIG. 3 is a high level flow chart showing a method of the social site module according to the present invention;

FIG. 4 is a high level flow chart showing the operation of a log-in and create user account module;

FIG. 5 is a high level flow chart showing the operation of a Virtual ID module according to the present invention;

FIG. 6 is a high level flow chart showing the operation of a post message module according to the present invention;

FIG. 7 is a high level flow chart showing the operation of Obtain Virtual ID Subroutine of the Virtual ID module where the system is configured to allow the user the option of entering a Virtual ID or having the system randomly generate a Virtual ID;

FIG. 8 illustrates a log-in web page according to the present invention;

FIG. 9 illustrates a home web page of the user according to the present invention after the user has signed into a previously created account. The web page is shown in a first color and/or image scheme indicative that the user is operating in real mode;

FIG. 10 illustrates the user's home web page according to the present invention after the user has activated a change identity mode button where the user is presented with a field or box to enter his or her Virtual ID PIN. The home web page is still shown in the first color and/or image scheme indicative that the user is operating in real mode;

FIG. 11 illustrates the user's home web page according to the present invention after the user has entered his or her Virtual ID PIN and switched to anonymous mode. The home web page shows a second color and/or image scheme indicative that the user is operating in anonymous mode as well as displaying the user's Virtual ID and all comments made under the Virtual ID in bold and italics or some other pattern or font;

FIG. 12 illustrates the user's home web page according to the present invention after user 60 has exited the anonymous bode by clicking or activating the Change Identity Mode Button. The home page shows the first color and/or image pattern indicating that the user is operating in real mode. The Real ID of user 60 is displayed and no difference is shown between any of the Virtual ID comments (whether by the user or another user);

FIG. 13 illustrates the contents of a user database according to the present invention;

FIG. 14 illustrates the contents of a picture database according to the present invention;

FIG. 15 illustrates the contents of a message database according to the present invention;

FIG. 16 is a high level flow chart showing the operation of a second embodiment of a social site module according to the present invention where the user enters his or her Virtual ID as part of the log-in and create user account module; and

FIG. 17 illustrates the operation of the log-in and create user account module according to the second embodiment of the present invention.

### DESCRIPTION OF THE INVENTION

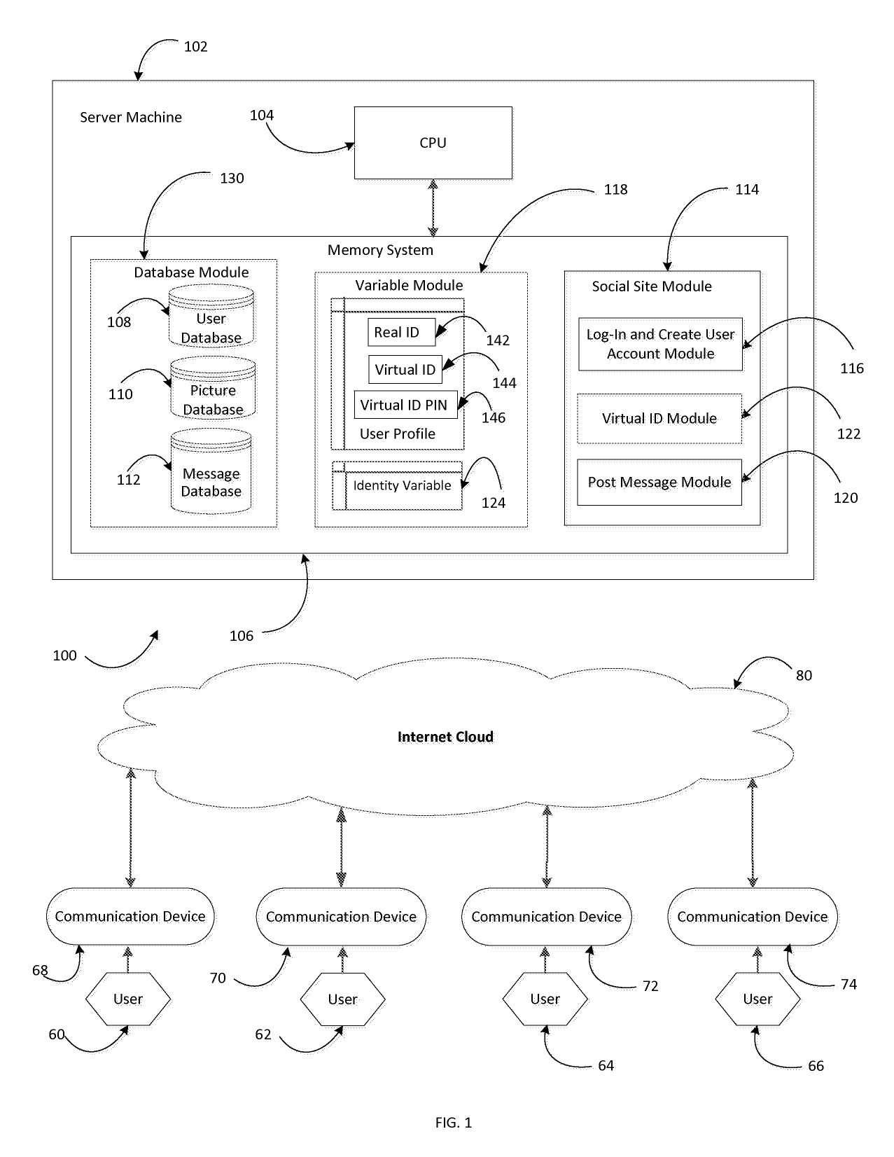

Referring to FIG. 1, a system 100 according to a first embodiment of the present invention generally comprises a web server machine 102 connected with an internet 80 that is adapted to host or operate a social networking site. One or more users 60, 62, 64, and 66 may interact with server machine 102 in a real mode or an anonymous mode using communication devices 68, 70, 72, and 74 connected to internet 80 by a conventional wireless and/or internet network. The term “web server machine” means any type of presently or futurely developed electronic device having one or more central processing units or other computing devices and local or remote server software for allowing communication over internet 80, including but not limited to, a web server, a file server, an embedded server, and a plug based server. The term “communication device” means any type of presently or futurely developed electronic device having a central processing unit and client software, including but not limited to, a personal computer and a wireless device such as a smart phone. In the embodiment shown, server machine 102 is a conventional web server such as Model No. Power Edge M520 available from Dell Computers (www.dell.com) having an Intel® microprocessor and a Microsoft® windows server operating system. In the embodiment shown, communication devices 68, 70, 72, and 74 are conventional personal desk top computer systems and/or wireless smart phones.

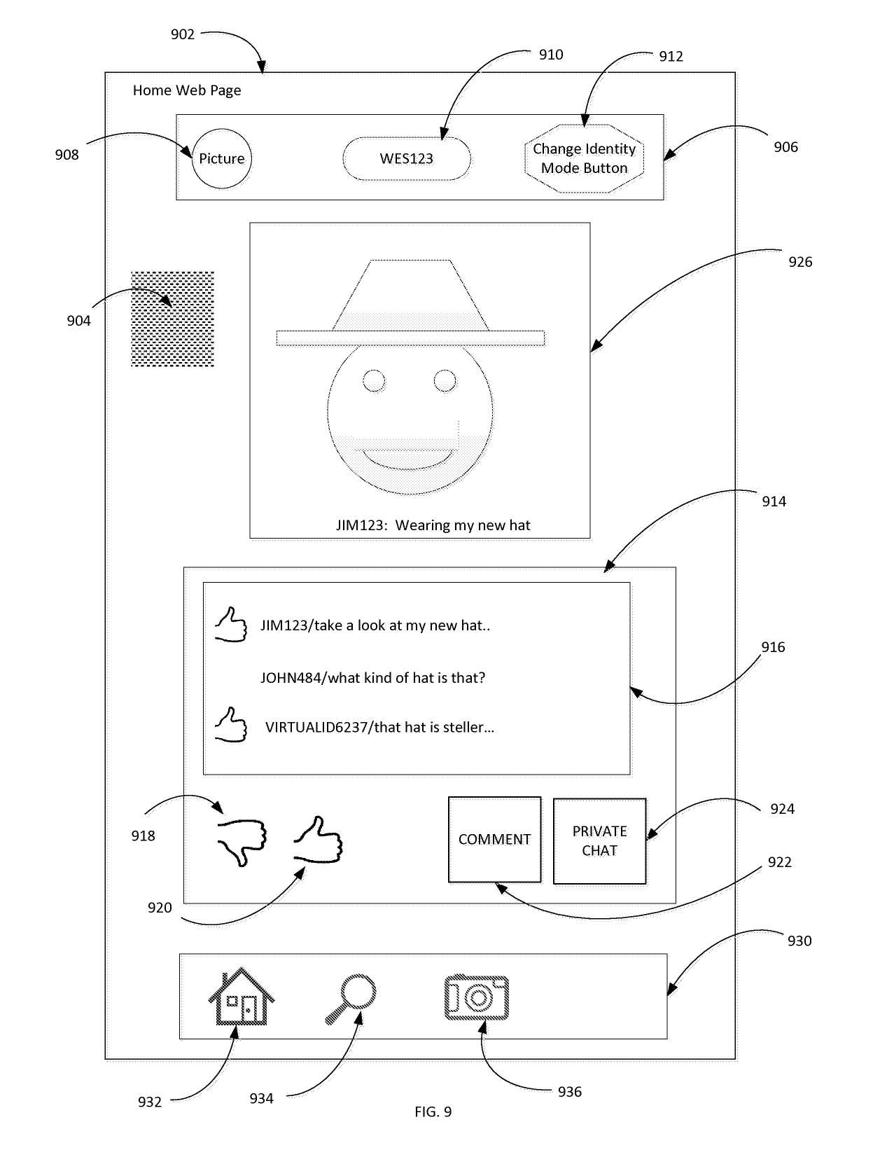

With continued reference to FIG. 1, server machine 102 generally comprises a central processing unit 104, a memory system 106, and a database 130 stored on memory system 106. Database 130 comprises a user database 108, a picture database 110, and a message database 112. Server machine 102 further comprises a variable module 118 stored on memory system 106. Variable module 118 comprises code configured to create the following variables for each user: Real ID 142, Virtual ID 144, and Virtual ID PIN 146, and an identity variable 124. Server machine 102 further comprises a social site module 114 stored on memory system 106. Social site module 114 generally comprises a log-in and create user account module 116 that allows user 60 to enter Real ID 142 and Virtual ID PIN 146, and other information that is stored in user database 108. Social site module 114 further comprises a Virtual ID module 122 that comprises code to create a change identity mode button 912 (FIG. 9) that can be activated by user 60 to switch between real mode and anonymous mode. Virtual ID module 122 further comprises code to create a Virtual ID 144 assigned to user 60 upon activation of change identity button 912. Virtual ID module 122 further comprises code adapted to create an identity variable 124 for user 60 that is set by default to the Real ID of user 60 and can be set to the Virtual ID assigned to user 60 upon activation of button 912. Social site module 114 further comprises a post message module 120 adapted to create a new post, send a message to a post, or start a private chat. All post message operations within any social networking function (pictures, chat, etc.) will display the user's Real ID or Virtual ID depending on the setting of identity variable 124. The term “module” means one or more computer instructions or code written in one or more programming languages. Social site module 114 and the various subroutines can be programmed in a variety of well-known programming languages (c#, f#, java, cgi, php, etc). Database code can be written using the programming language used or through the database programming language, such as SQL.

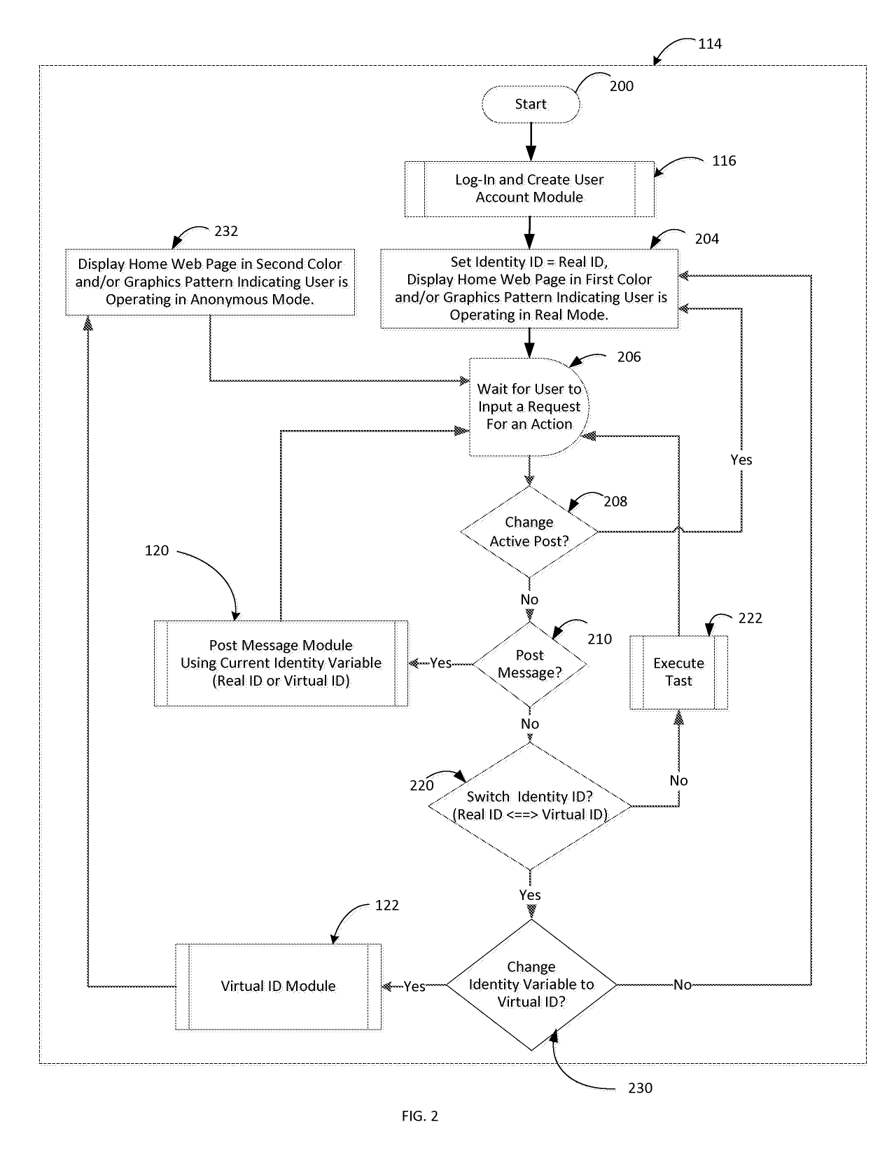

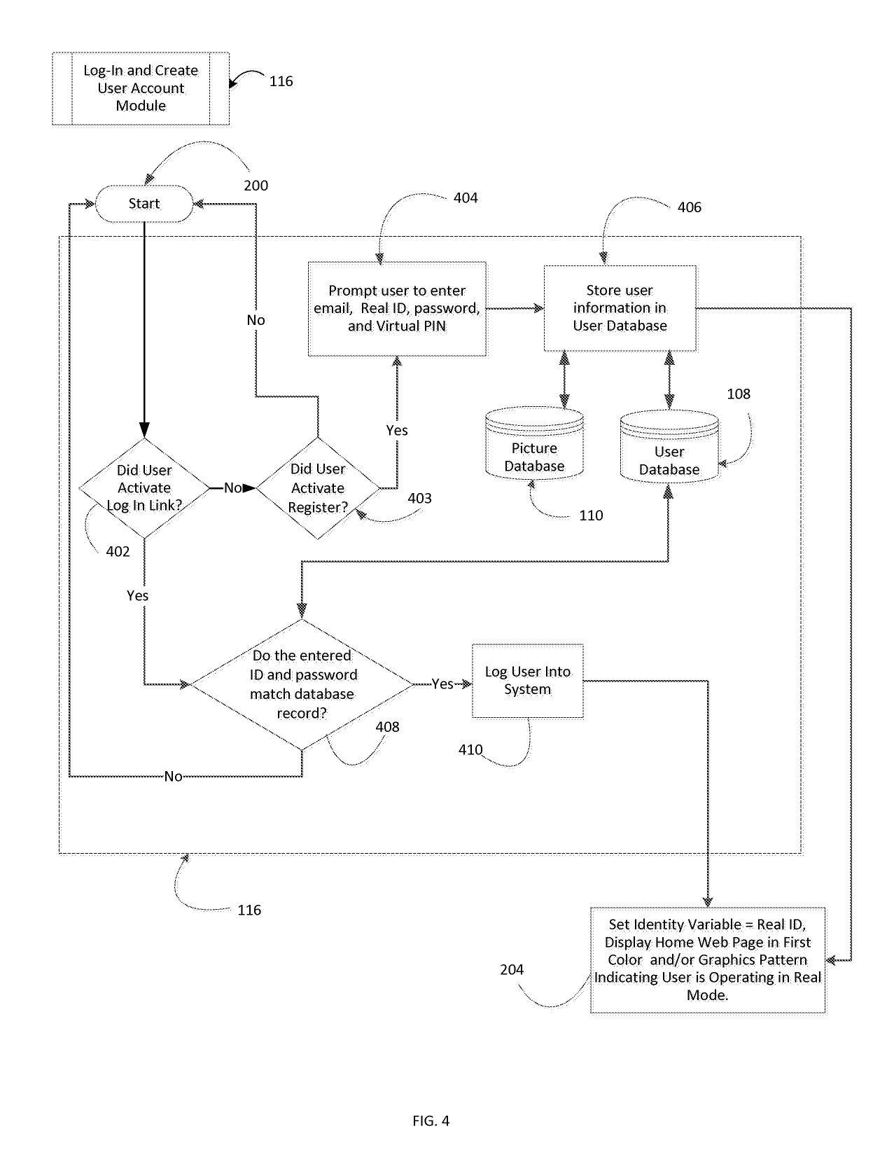

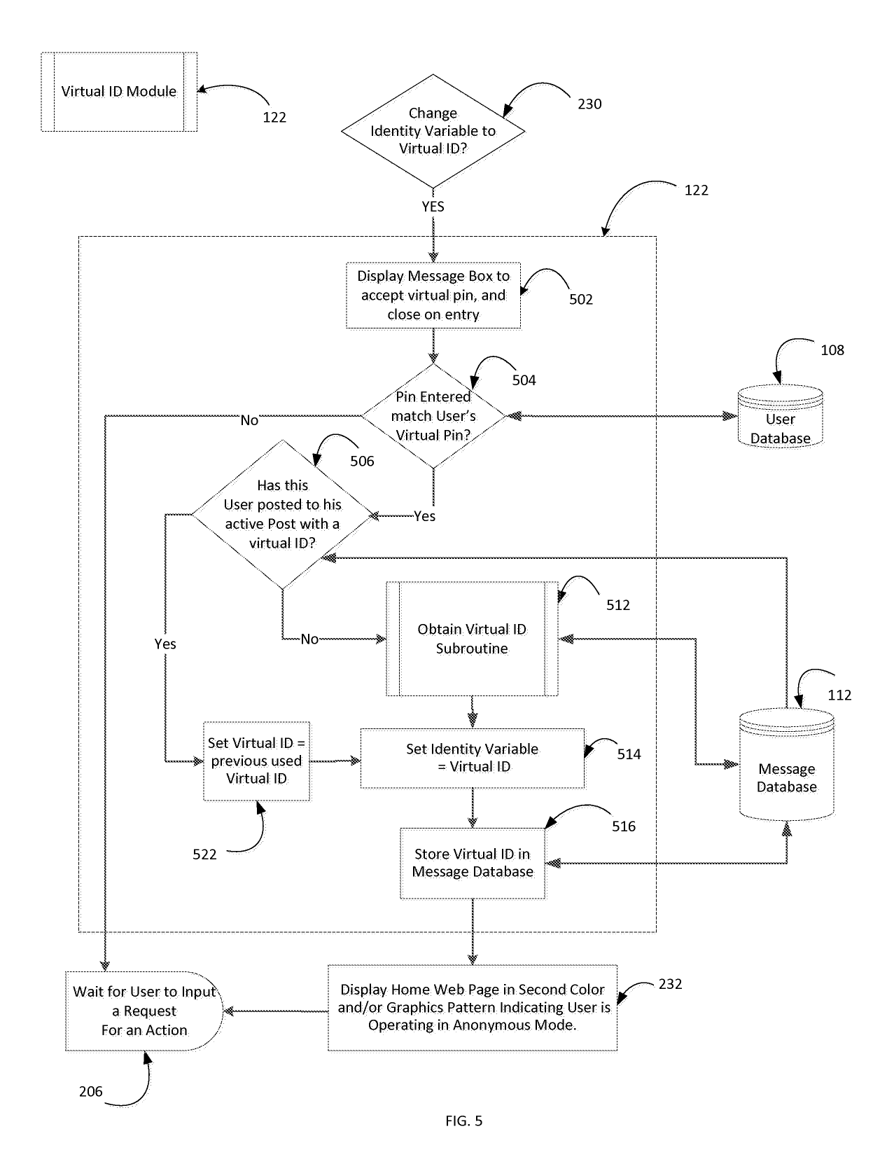

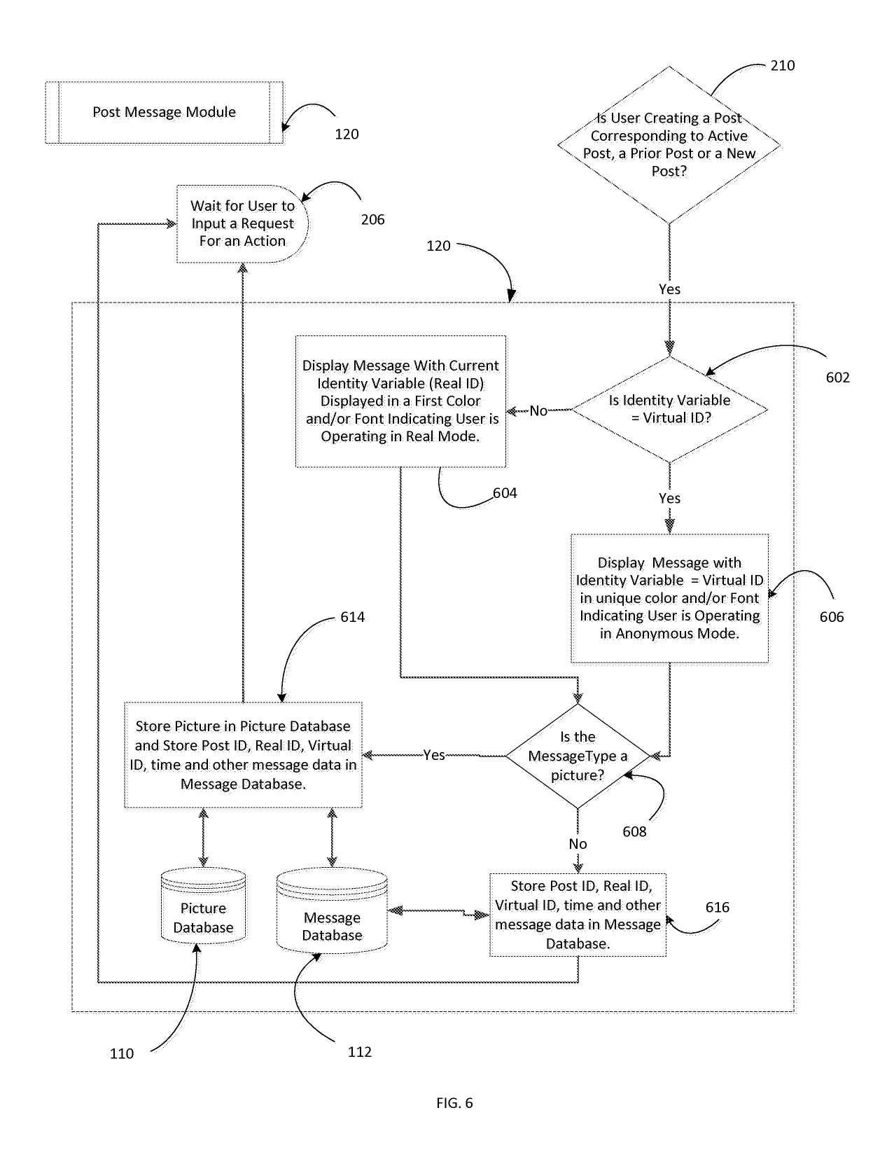

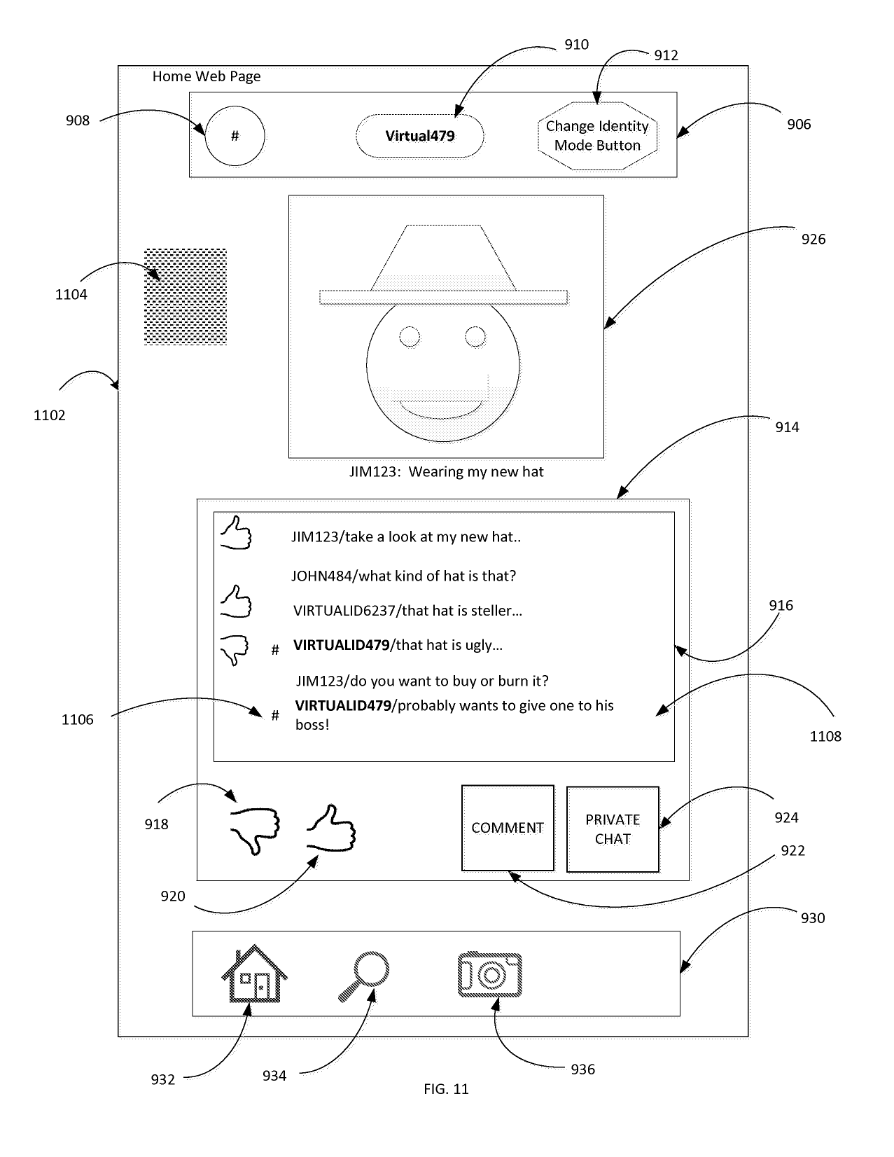

Referring to FIG. 2, where operation of social site module 114 is described. As indicated by a block 200, social site module 114 comprises code adapted to start operation of the software. Control is passed to log-in and create user account module 116. As will be described more fully in connection with FIG. 4, log-in and create user account module 116 implements a user sign-on and account creation operation where user 60 creates an account by entering in various information, including a User name or screen name that becomes the user's Real ID, a password, a Virtual ID PIN, and any other information as well as sign-on function allowing user's with the proper access information to log-in and utilize the system. After user 60 has logged into system 100, control is passed to a block 204 where social site module 114 comprises code to set identity variable 124 (FIG. 1) to the user's Real ID (user name) and to serve or display a home page 902 with a first color scheme and/or graphic pattern 904 (FIG. 9) indicating that user 60 is operating in a real mode. As will be described more fully herein, social site module 114 may further comprise code to display a real picture of user 60 in a field 908 (FIG. 9) and the Real ID of user 60 in a field 910 (FIG. 9) of home page 902 to further inform user 60 that he or she is operating in real mode. Control is then passed to a block 206 where system 100 waits for user 60 to input a request for an action. When a request is issued, control is passed to a decisional block 208 where social site module 114 comprises code to determine if user 60 has chosen to change the active post. If the request from user 60 is to change the active post, then control is returned to block 204. Returning to block 208, if this is not a request to change the active post, then control is passed to a decisional block 210 where social site module 114 comprises code to determine if user 60 wants to post a message (comment or chat on active post). If the request for an action by user 60 is to post a message then control is passed to post message module 120. As will be more fully described in connection with FIG. 6, post message module 120 uses identity variable 124 to post a message, comment or chat on active post set to Real ID or Virtual ID. The new message, chat or post is created, and displayed according to the setting of identity variable 124. If identity variable 124 is set to the Real ID then post message module 120 will serve or display home page 902 (FIG. 9) of user 60 with the comments of the post in a first color scheme and/or graphic pattern 904 (FIG. 9) indicating that user 60 is operating in a real mode. If identity variable 124 ID is set to the Virtual ID then post message module 120 will serve or display home page 1102 of user 60 with the comments of the post in a second color scheme and/or graphic pattern (FIG. 11) indicating that user 60 is operating in anonymous mode. By way of example only, the message posted by user 60 may be a comment on another user's post of a picture or a comment made in a private chat with another user or any other presently existing or futurely developed social interaction routine. When posting of the message is complete, social site module 114 returns control to block 206 where system 100 waits for user 60 to input a request for an action. Returning to decisional block 210, if the user's request for an action is not to post a message then control is passed to a decisional block 220. As indicated by decisional block 220, social site module 114 comprises code to determine if the request for action is to switch his or her identity variable 124 between Real ID (real mode) and Virtual ID (anonymous mode). If user 60 did not request a switch between Real ID and Virtual ID then control is passed to a block 222 where social site module 114 comprises code to execute the request for action by user 60 which may be, for example, to post a picture, search, or any other function. After completing execution of the request, control is again passed to block 206 where social site module 114 waits for user 60 to make a request for an action. Returning to block 220, if social site module 114 determines that identity variable 124 of user 60 should be switched then control is passed to a decisional block 230. As shown by decisional block 230, social site module 114 comprises code to determine if user 60 wants to change identity variable 124 to a Virtual ID. If user 60 has requested to change Identity Variable 124 to a Virtual ID then control passes to Virtual ID module 122. As will be more fully described with reference to FIG. 5, Virtual ID module 122 comprises code to create a Virtual ID for User 60; store the Virtual ID in message database 112; and set or change identity variable 124 to the newly created Virtual ID. When Virtual ID module 122 is complete, control is passed to a block 232 where social site module 114 comprises code to display a home page 1102 (FIG. 11) in a second color and/or graphics pattern 1104 indicating user 60 is operating in anonymous mode. As will be described more fully herein, social site module 114 may further comprise code to display a fictitious image such as a mask in field 908 and the Virtual ID of user 60 in field 910 of home page 1102 to further inform user 60 that he or she is operating in anonymous mode. Control is then returned to block 206 where social site module 114 waits for user 60 to make a request for action. Returning to decisional block 230, if user 60 is not changing identity variable 124 to a Virtual ID then control returns to block 204, where the virtual ID is set to the user's Real ID, and home page 902 is displayed with pattern 904 again indicating that user 60 is operating in real mode (FIG. 9). Control is returned to block 206 where social site module 114 waits for user 60 to make a request for an action.

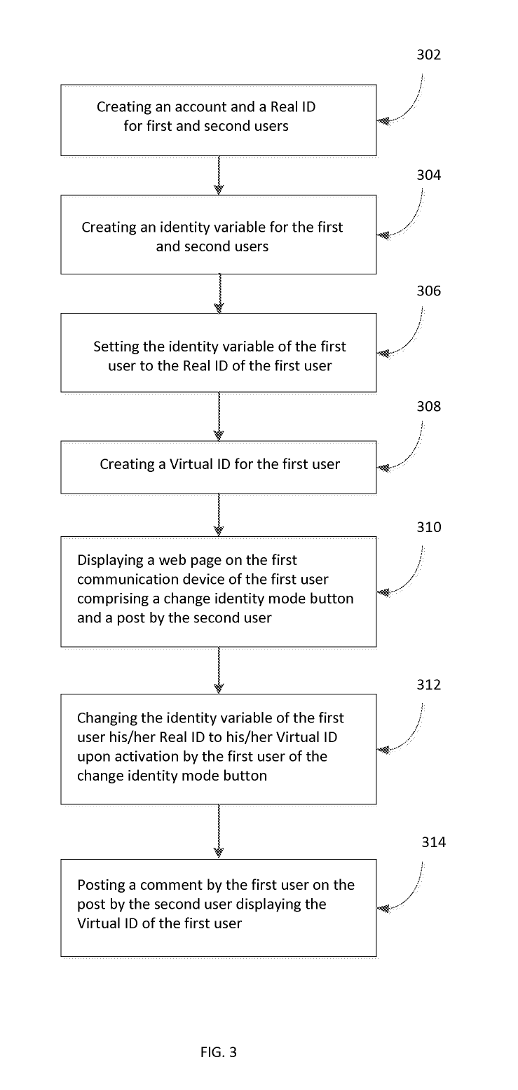

Referring to FIG. 3, where a high level block diagram shows a method of social site module 114. As shown by a block 302, social site module 114 comprises a step of creating an account and a Real ID for first and second users. As shown by a block 304, social site module 114 comprises a step of creating an identity variable for the first and second users. As shown by a block 306, social site module 114 comprises a step of setting the identity variable of the first user to the Real ID of the first user. As shown by a block 308, social site module 114 comprises a step of creating a Virtual ID for the first user. As shown by a block 310, social site module 114 comprises a step of displaying a web page on the first communication device of the first user comprising a change identity mode button and a post by the second user. As shown by a block 312, social site module 114 comprises a step of changing the identity variable of the first user from Real ID to Virtual ID upon activation by the first user of the change identity mode button. As shown by a block 314, social site module 114 comprises a step of posting a comment by the first user on the post by the second user displaying the Virtual ID of the first user.

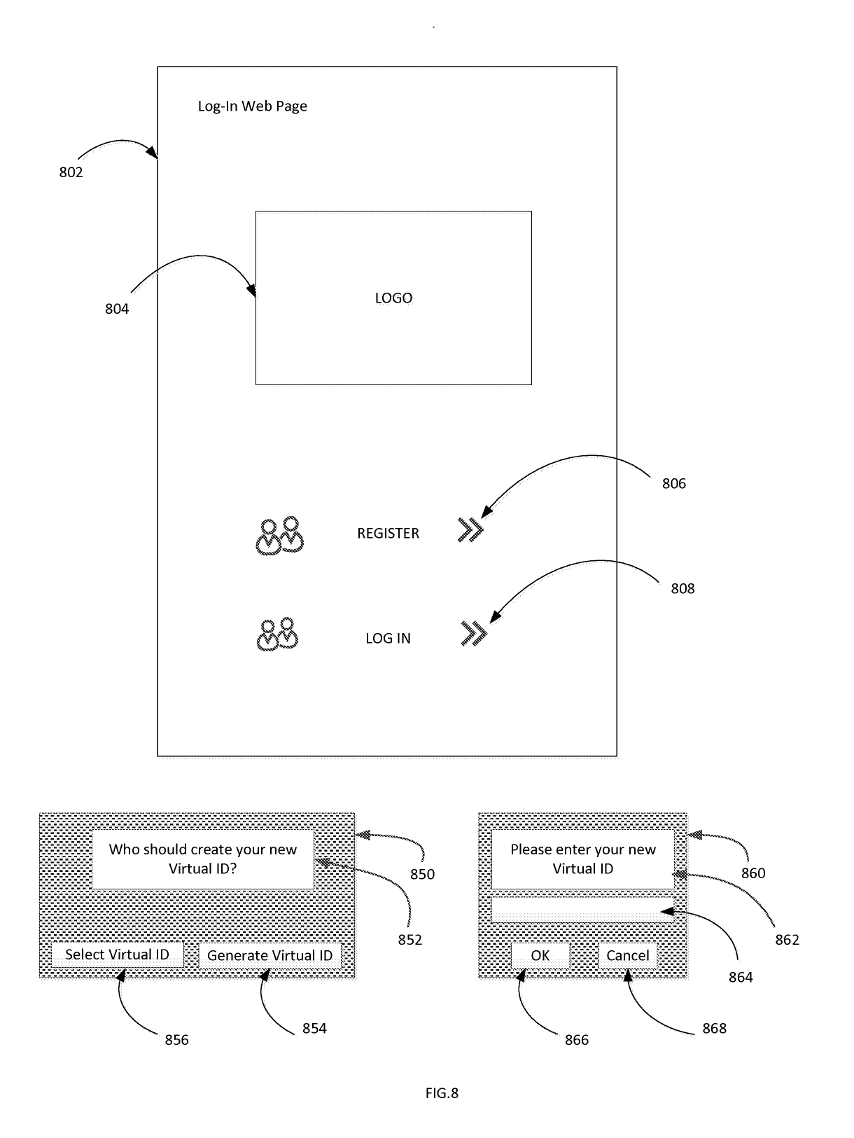

Referring to FIG. 4, where operation of log-in and create user account module 116 is described. As indicated by a decisional block 402, module 116 comprises code configured to determine whether user 60 has activated a log-in link 808 of a log-in web page 802 (FIG. 8). If user 60 did not activate log-in link 808, control is passed to a decisional block 403 to determine if user 60 activated a register link 806 of log-in web page 802. If user 60 activated register link 806, then control is passed to a block 404 where module 116 comprises code to create an account for user 60. Block 404 also comprises code to create identity variable 124. After the account of user 60 is created, control is passed to a block 406 where module 116 comprises code adapted to prompt and store the Real ID 142, password, Virtual ID PIN 146 and other information collected from user 60 in user database 108 as well as the user's picture in picture database 110. Once this is completed, control is passed to block 204 (FIG. 2). Returning to decisional block 403, if user 60 did not activate register link 806, control is returned to start block 200, awaiting user action. Returning to decisional block 402, if user 60 activated the log-in link 808 then control is passed to a decision block 408 where module 116 comprises code adapted to check if the Real ID and password entered by the user matches one or more records in user database 108. If they match, then (in this case) control is passed to block 410 which will log user 60 into system. After user 60 has logged into system 100 control is passed to a block 204. Returning to decision block 408, if the Real ID and password do not match a record in user database 108 control is passed back to block 200 where, although not shown, a web page with an error message may be served requesting user 60 to re-enter his or her user name and password or to click a link for recovery of the user name and/or password.

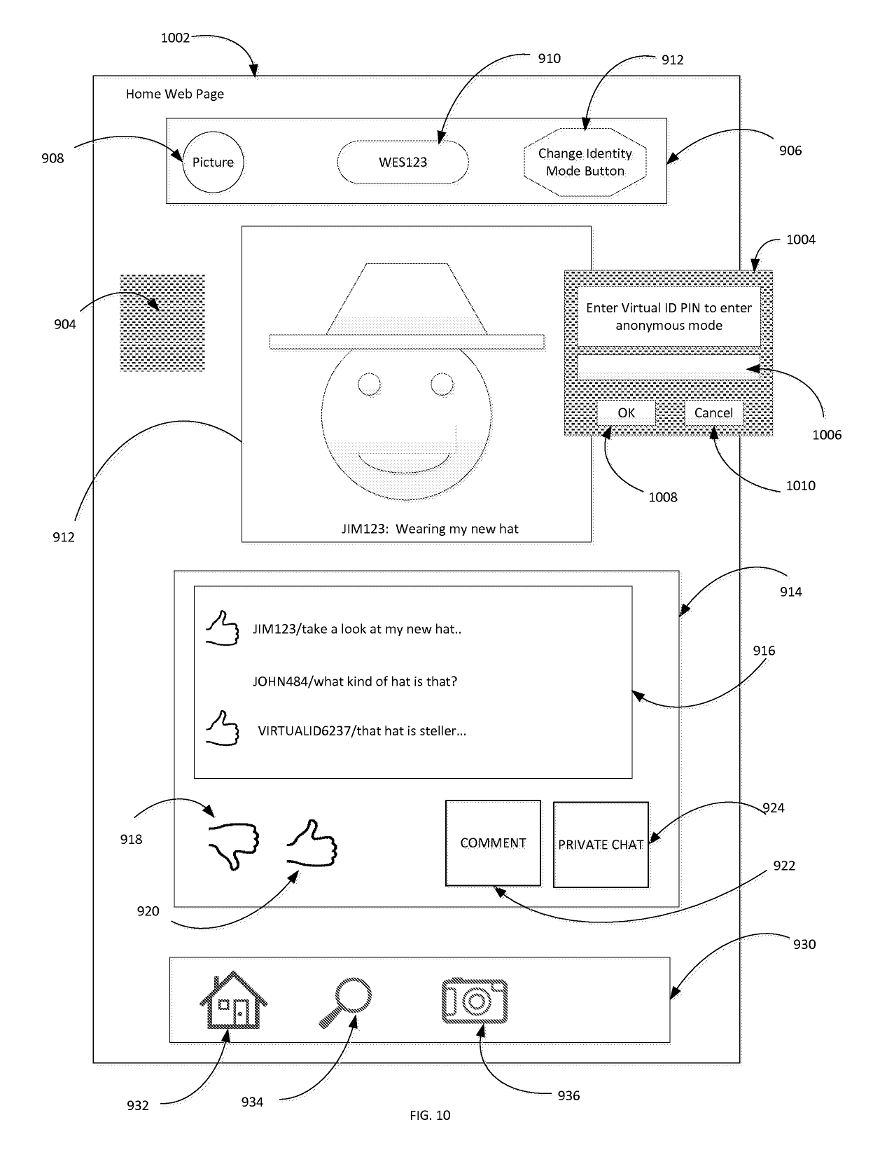

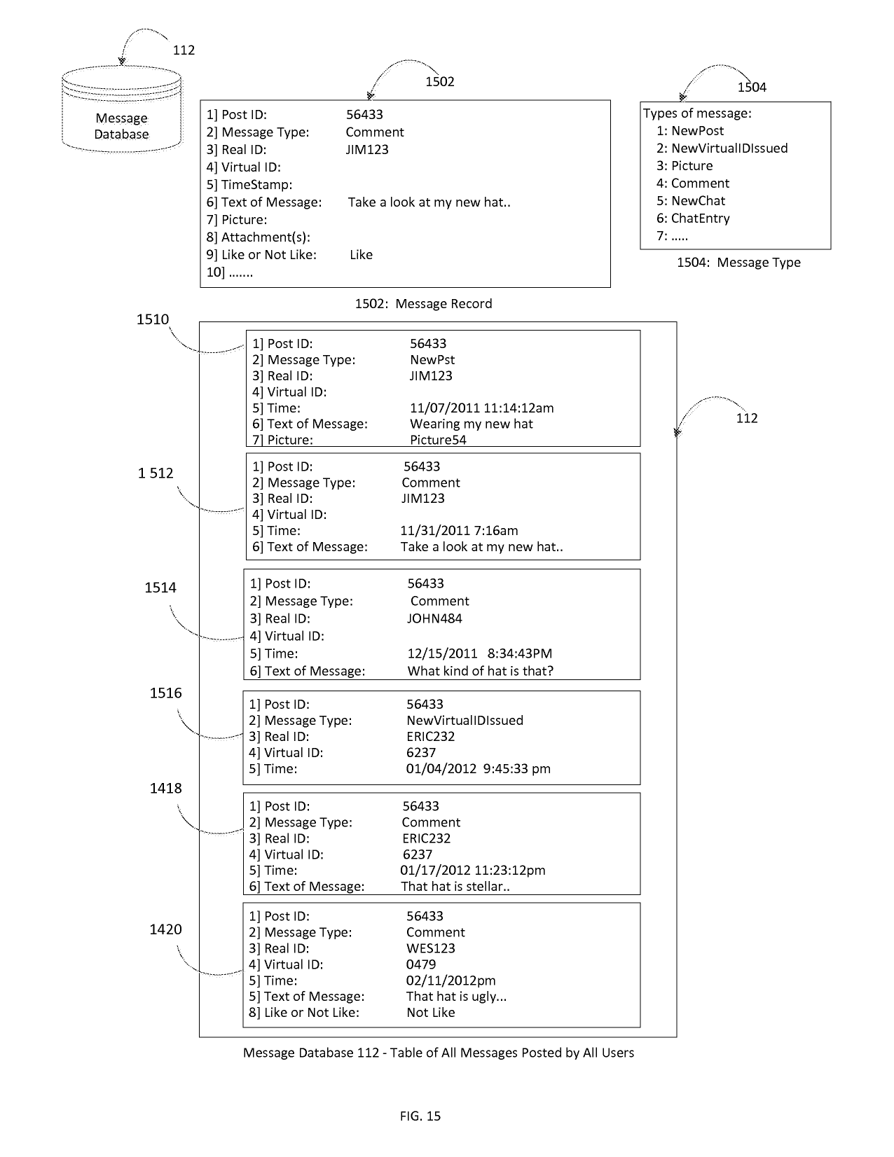

Referring to FIG. 5, where operation of Virtual ID module 122 is described. As indicated by a block 502, module 122 comprises code configured to display a message box 1004 (FIG. 10) on a web page 1002 prompting user 60 for his or her Virtual ID PIN that permits use 60 to enter anonymous mode using a Virtual ID. The Virtual ID PIN was entered by user 60 as part of the operation of log-in and create user account module 116. As indicated by a decisional block 504, module 122 comprises code to check the Virtual ID PIN entered by user 60 against the Virtual ID PIN entered by user 60 and stored in user database 108. If the Virtual ID PIN entered by user 60 does not match the Virtual ID PIN stored in user database 108 then control passes to block 206 (FIG. 2) which waits for user 60 to request an action to be performed. Although not shown, an error message box could be served to user 60. Returning to decision block 504, if user 60 entered the proper Virtual ID PIN then control is passed to a decisional block 506 where module 122 comprises code to check the log of messages posted by user 60 stored in message database 112 to see if user 60 has posted to this active post in anonymous mode in the past. One method of checking is to issue a SQL request which would resemble “Select Distinct Virtual ID from Message Database where RealID=Wes123 AND Message=P23432 and VIRTUALID!=BLANK and MessageType=NewVirtualIDIssued” which will return any Virtual ID previously used by user 60 to a given post. If user 60 has previously used a Virtual ID with a current post, then control is passed to a block 522 where the Virtual ID is set to the previously used Virtual ID stored in message database 112. Control is passed to a block 514 where module 122 comprises code to set identity variable 124 for user 60 equal to the Virtual ID. Returning to decisional block 506, if user 60 has not posted to this active post in anonymous mode in the past then control is passed to an Obtain Virtual ID Subroutine 512. As will be described more fully herein, Subroutine 512 comprises code that allows user 60 the option of entering a unique Virtual ID or allowing the system to randomly generate a unique Virtual ID. Control is passed to a block 514, where module 122 comprises code to set identity variable 124 to the Virtual ID. Control is passed to a block 516, where module 122 comprises code to store the Virtual ID in message database 112 (FIG. 1). Module 122 further comprises code to build a message record 1502 shown in FIG. 15 (to be described) that is stored in message database 112. Message record 1502 comprises the Post ID, Real ID, Virtual ID, message type and time, associated with the post. The message type would be the NewVirtualIDIssued. Control is passed to block 232 (FIG. 2) where module 114 comprises code to display the home web page in second color and/or graphics pattern indicating user 60 is operating in anonymous mode as previously described. Control is returned to block 206 where social site module 114 waits for user 60 to input a request for an action.

Referring to FIG. 6, where operation of post message module 120 is described. Operation begins with a decisional block 602 where post message module 120 comprises code adapted to determine whether Identity Variable 124 (FIG. 1) is set to the Virtual ID of user 60. If the Identity Variable 124 is not set to the Virtual ID of user 60, control is passed to a block 604 where module 120 comprises code adapted to display the message of user 60 with Identity Variable 124 as currently set to the Real ID of user 60 in a first color and/or font type indicating that user 60 is operating in real mode. Control is passed to a decisional block 608 where module 120 comprises code to determine if the message type is a picture. If there is a picture in the message type then control is passed to a block 614 where module 120 comprises code to store the picture in picture database 110 (FIG. 1) and to create and store a post message record in message database 112 (FIGS. 1 and 15) containing the message type (picture, etc.), Real ID, current time, and the newly generated Picture ID. Control is returned to block 206 where social site module 114 waits for user 60 to make a request for an action. Returning to decisional block 608, if no picture is part of the user's post, then control is passed to block 616 which creates and stores a post message record 1502 in message database 112 (FIGS. 1 and 15) containing the Message Type, Real ID, Virtual ID, current time, and any comments or other attachments. Control is returned to block 206 where social site module 114 waits for user 60 to make a request for an action. Returning to block 602, if identity variable 124 is set to the Virtual ID of user 60 then control is passed to a block 606 where module 120 comprises code adapted to display the message of user 60 with current Identity Variable 124 set to the Virtual ID in a second color and/or font type which indicates that user 60 is operating in anonymous mode. Control is passed to decisional block 608, where post message module 120 operates as described above.

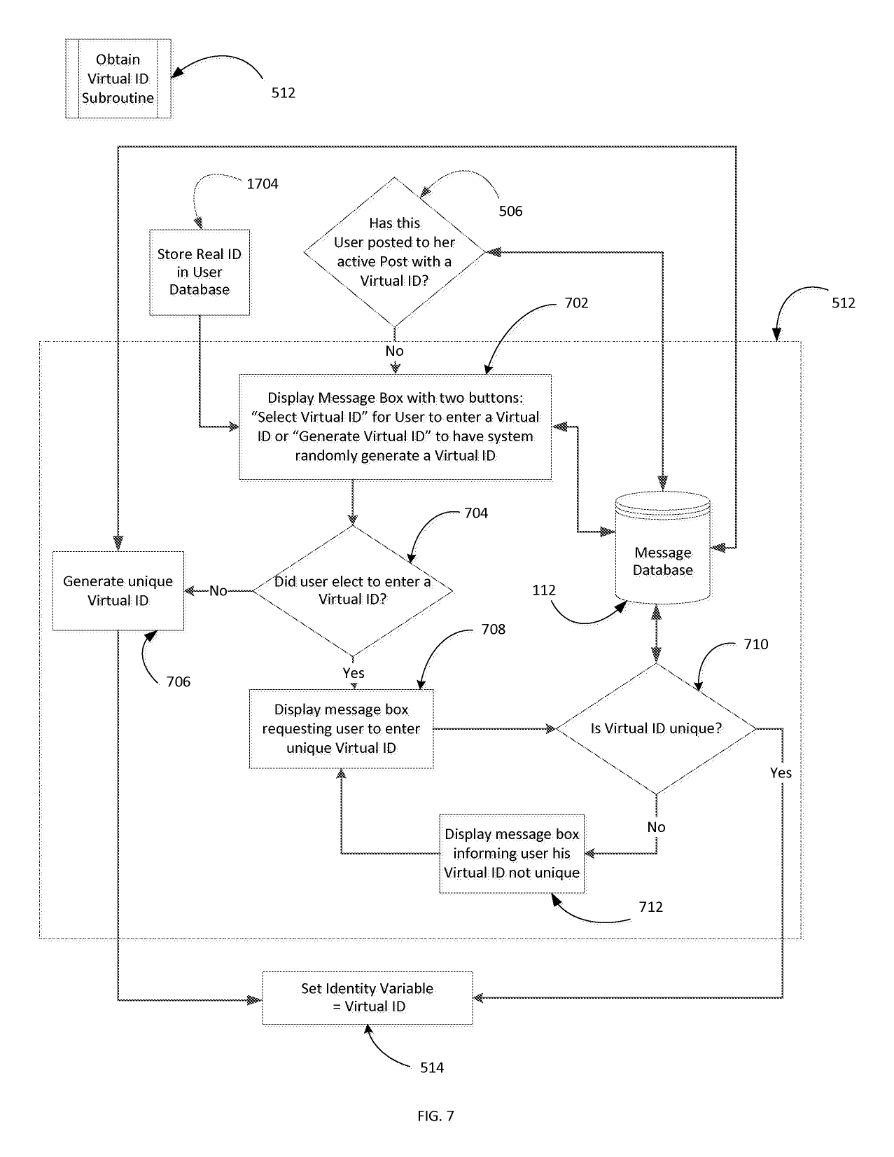

Referring to FIG. 7, where a high level flow chart shows the operation of Obtain Virtual ID Subroutine 512 (FIG. 5) of Virtual ID module 122 (FIG. 5). As indicated by block 506 of FIG. 5, if user 60 has not previously posted to his active post with a Virtual ID, control is passed to a block 702 where Subroutine 512 comprises code to display a message box 850 (FIG. 8) with a Generate Virtual ID button 854 (FIG. 8) which when activated instructs system 100 to randomly generate a Virtual ID, and a Select Virtual ID button 856 (FIG. 8) which when activated displays a message box 860 (FIG. 8) which allows user 60 to enter his or her Virtual ID. Control is passed to a decisional block 704 where Subroutine 512 comprises code to determine whether user 60 elected to enter a Virtual ID. If user 60 did not elect to enter his or her Virtual ID then control is passed to a block 706 where Subroutine 512 comprises code to create and store a unique Virtual ID for user 60 in message database 112. Control is passed to block 514 of FIG. 5 where identity variable 124 is set to the Virtual ID. Returning to decisional block 704, if user 60 elects to enter his or her Virtual ID then control is passed to a block 708 where Subroutine 512 comprises code to display a message box prompting user 60 to enter a unique Virtual ID. Control is passed to a decisional block 710 where Subroutine 512 comprises code to determine whether the Virtual ID entered by user 60 is unique by checking the Virtual IDs for all users stored in message database 112. If the Virtual ID entered by user 60 is unique then control is returned to block 514 (FIG. 5) where Identity Variable 124 is set to the Virtual ID entered by user 60. Returning to decisional block 710, if the Virtual ID entered by user 60 is not unique then control is passed to a block 712 where Subroutine 512 comprises code to display a message box informing user 60 that his or her Virtual ID is not unique. Control is returned to block 708 where user 60 is prompted to enter a new unique Virtual ID and the process is repeated as described before.

Referring to FIG. 8, where a log-in web page 802 is illustrated. Web page 802 comprises a logo 804, a register link 806, and a log-in link 808. Clicking or activation of register link 806 allows user 60 to create an account with system 100 which has been described in connection with log-in and create user account module 116 (FIG. 4). Another web page (not shown) would be served prompting user 60 to enter his/her screen name, password, and other personal information. Clicking or activation of log-in link 808 allows user 60 to log on to system 100 which has been described in connection with log-in and create user account module 116 (FIG. 4). Another web page (not shown) may be served prompting user 60, for example, to enter his/her screen name and password. One implementation of this algorithm will prompt the user to create a Virtual ID when the user profile is created. Message box 850 further comprises a text box 852 informing the user to choose if they or the system will select their Virtual ID. Message box 850 further comprises a Generate Virtual ID button 854 which will lead to system 100 generating a Virtual ID for the user. Message box 850 additionally comprises a button Select Virtual ID 856 which will cause the system to generate another message box 860. Message Box 860 comprises a text box displaying a message box to inform the user to enter their new Virtual ID. Message Box 860 further comprises an edit text box 864 allowing the user to enter a proposed Virtual ID. Message box 860 further comprises an OK button 866 which will execute a check of previously created user names and virtual names and ensure that this name fits the criteria of legal Virtual ID names. Message box 860 further comprises a cancel button 868 which will return the user to display message box 850.

Referring to FIG. 9, where a web page 902 has been served and displayed on communication device 68 after user 60 logs on to system 100. Web page 902 comprises a first color and/or graphics pattern background 904 (only a partial section of web page 902 is shown) indicating to user 60 that he or she is operating and/or communicating within system 100 in real mode and not anonymous mode. Web page 902 further comprises a User Identity box 906 comprising an image display field 908, a user identification display field 910, and a change identity mode button 912. Image display field 908 is an image of user 60 when operating in real mode and an image of a symbol # or any other symbol such as a mask when operating in anonymous mode. Identification display field 910 displays the identity variable 124 of user 60 which in the example shown is set to Real ID, namely, WES 123. Button 912 permits user 60 to enter and exit anonymous mode. Clicking or activation of button 912 when in real mode activates Virtual ID module 122 (FIG. 5). Web page 902 further comprises a post field 926 that illustrates a picture posted by another user or member having a Real ID of JIM123. Web page 902 further comprises a message creation and comment block 914 comprising a comment display field 916 to display various messages or comments to a picture posted by another user. Block 914 is adapted to allow user 60 to enter various comments relating to the picture posted by another user (JIM123) in post field 916. Block 914 further comprises a thumbs down button 918 which when activated posts a thumbs down image on the user's comment in comment block 916. Similarly, block 914 further comprises a thumbs up button 920 which when activated posts a thumbs up image on the user's comment in comment block 916. Block 914 further compromises a comment button 922 which when activated displays the Real ID or Virtual ID of the user and an input field allowing the user to post a text comment in the comment block 916. If the user is in anonymous mode, the virtual user name will be displayed with a symbol 1106 marking anonymous mode as shown in connection with FIG. 11 (to be described). Block 914 further compromises a private chat button 924 which will opens a private chat with the user who created post 926. Web page 902 further comprises a lower navigation box 930 having a home page request button 932, a search request button 934, and a post picture request button 936. Each of request buttons 932, 934, and 936 when activated causes a corresponding request to be sent to block 206 (FIG. 2) and processed by execute task block 222.

Referring to FIG. 10, where a web page 1002 of user 60 is illustrated after user 60 clicks or activates button 912 while in real mode that activates block 702 (FIG. 7) as previously described. Web page 1002 contains a message box 1004 having a field 1006 configured to allow user 60 to enter a Virtual ID PIN that permits user 60 to enter anonymous mode. Message box 1004 further comprises an OK link 1008 that when clicked or activated will activate decision block 504 (FIG. 5) to process the Virtual ID PIN upon activation by user 60. User 60 must enter his or her Virtual ID PIN to switch from real mode to anonymous mode. The Virtual ID PIN entered by user 60 must match a previously stored authorized Virtual ID PIN in order for user 60 to enter anonymous mode. User 60 is not required to enter a Virtual ID PIN to switch back from anonymous mode to real mode and this message box would not be displayed. Message box 1004 further comprises a cancel link 1008 which, when activated, will cancel the switch from real mode to anonymous mode and leave the user in the previous state of real mode.

Referring to FIG. 11, where a web page 1102 of user 60 is illustrated after user 60 clicks or activates button 912, the system has verified the user's Virtual ID PIN and has repainted the screen showing the page in anonymous mode. The following description will list the changes that have been made to the web page as displayed in real mode (FIG. 9). The application background color is drawn in a second specific color scheme and/or graphic pattern 1104 indicating that user 60 is operating in anonymous mode. Display field 910 now displays the user's Virtual ID, VIRTUAL479 in the example shown. Display field 908 now displays a hash tag or another symbol indicating user 60 is currently operating in anonymous mode. When user 60 clicks or activates comment box 922 or private chat box 924, they will operate similarly to their operation in FIG. 9, with the change that the name displayed will now be the Virtual ID. As indicated by decision block 230 (FIG. 2), social site module 114 comprises code to determine if user 60 is switching to anonymous mode. Because user 60 is already in anonymous mode the software will execute block 204 (FIG. 2) which will set identity variable 124 to the Real ID of user 60 and redisplay the home page in real mode.

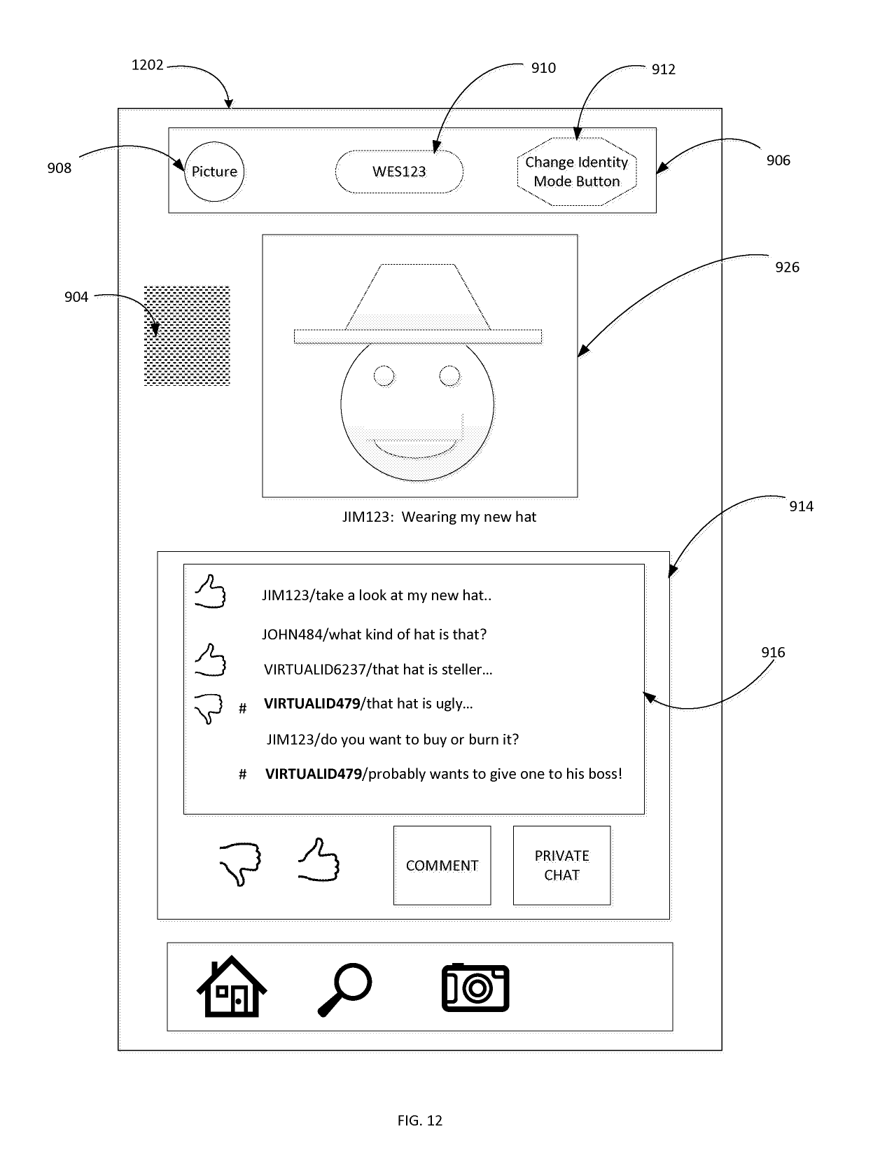

Referring to FIG. 12, where a web page 1202 is illustrated after user 60 clicks or activates change identity mode button 912 a second time returning user 60 to real mode. Home page 1202 comprises a first color and/or graphics pattern 1204 indicating to user 60 that he/she is operating and/or communicating with system 100 in real mode and not anonymous mode. Additionally, image display field 908 (picture) will again display a small image chosen by user 60 which indicates he is operating in real mode. Display field 910 now displays the Real ID (Wes123) of user 60. Block 916 shows all comments on this post made by other users in standard text. There is no way for anyone to see which, if any, of the virtual comments were made in anonymous mode by another user.

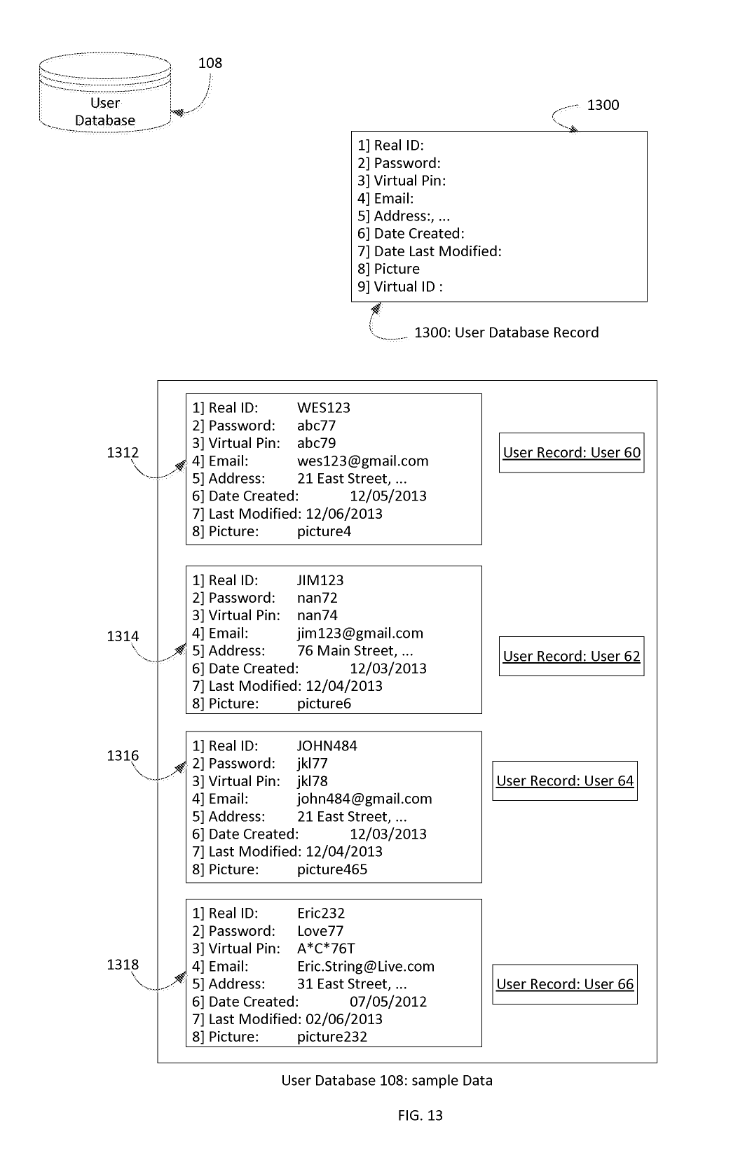

Referring to FIG. 13, where user database 108 is illustrated. Each database entry 1300, contains the Real ID [1], Password [2], and Virtual ID PIN [3] of each user, as well as the date created [6], the last record update [7] and the last generated or user entered Virtual ID. The user enters his or her information as described in connection with the operation of log-in and create user account module 116 (FIG. 4). User 60 may also enter other information such as his or her email, home address, and phone number. User record 1312, 1314, 1316 and 1318, stored in the user database 108, correspond to the user data base records of users 60, 62, 64 and 66. The entries to user database 108 are created by block 406 (FIG. 4).

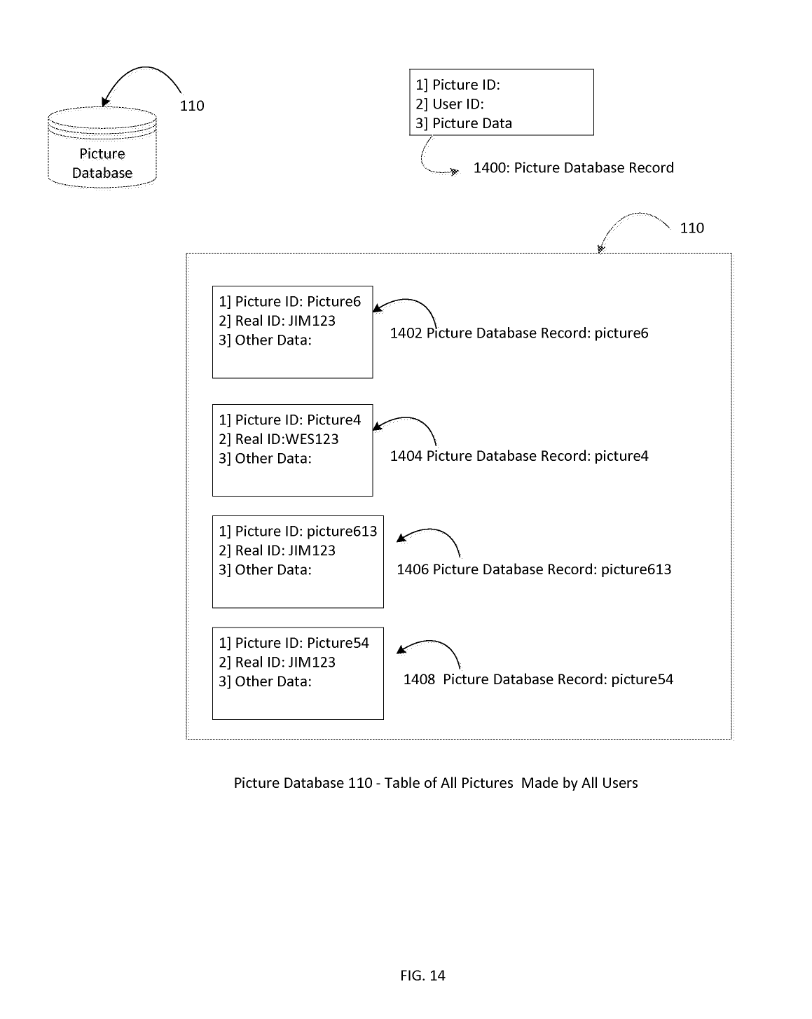

Referring to FIG. 14, where picture database 110 is described. Picture database 110 contains all pictures posted or entered by all users. Each database entry or record 1402 contains a Picture ID corresponding to the picture and the Real ID of the user who posted the picture. The entries to picture database 110 are created by block 614 (FIG. 6).

Referring to FIG. 15, where message database 112 is described. Each database entry 1502 contains the Post ID, the Message Type, Real ID, and identity variable as well as any other field(s) needed to contain the post data. For example, if user 60 presses the camera icon 920 to take a picture and post it as a new message, system 100 will generate a new Post ID [1] for this message and all associated commentary. The message type [2] will be set to 3 [indicating a message containing a Picture]. The Real ID [3] and Virtual ID [4] of user 60 will be recorded as well as the text of any message [6] associated with the post. Picture [7] will reference the picture ID 1400 that is associated with this post. If the user posts a comment to a previous post, the Post ID will be identical to that previous post. Message type [2] will equal 4, indicating a comment on another message. Note that pictures, text, voice or other attachments can be part of the comment depending on how database entry 1502 is filled in by the software. The entries to message database 112 are created by block 614 or 616 (FIG. 6).

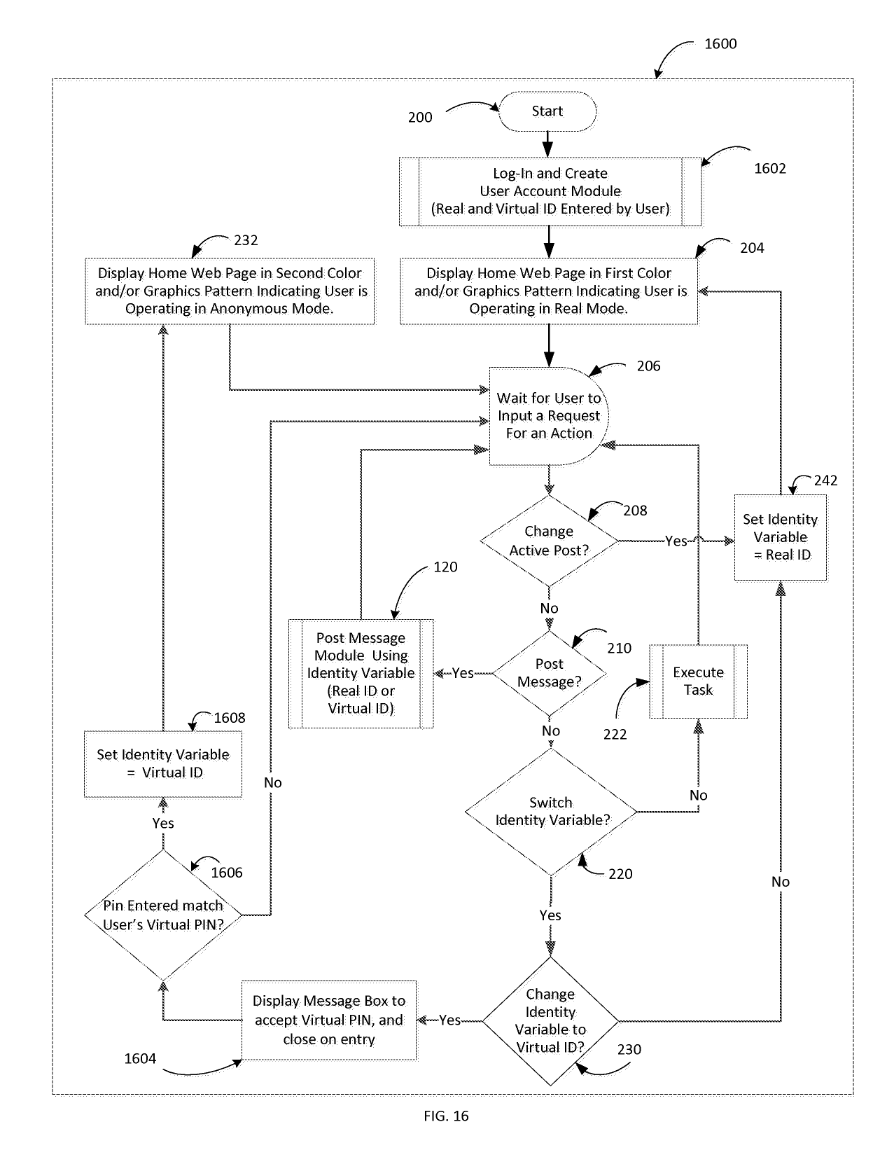

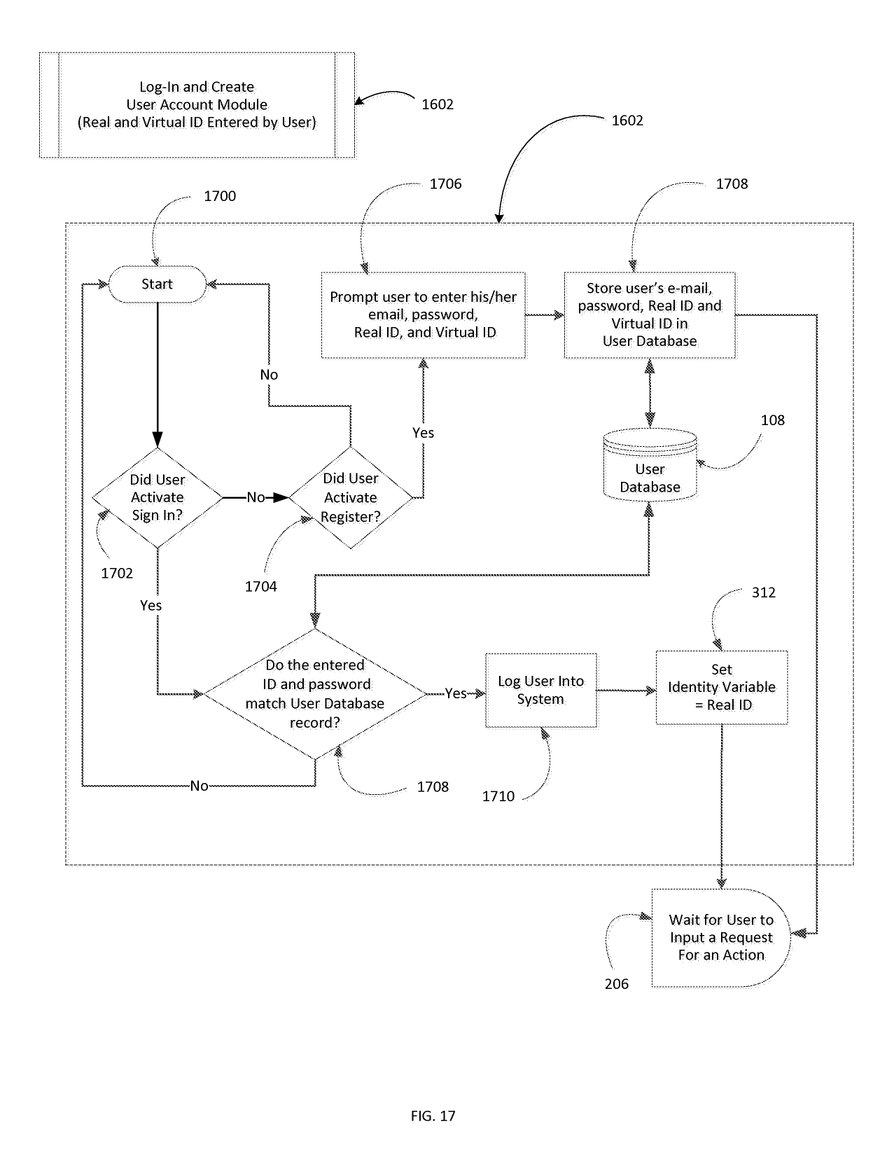

Referring to FIG. 16, where a second embodiment of a social site module 1600 is shown. As indicated by a log-in and create user account module 1602 (FIG. 17), social site module 1600 comprises code so that user 60 enters his or her unique Virtual ID as part of creating the user's account and not Virtual ID module 122 as in the first embodiment. Further, Virtual ID module 122 has been replaced with blocks 1604, 1606, and 1608. As indicated by block 1604, social site module 1600 comprises code to display a message box to accept a Virtual PIN entered by user 60 which closes upon entry. Control is passed to block 1606 where social site module 1600 comprises code to determine whether the Virtual PIN entered by user 60 matches the user's Virtual PIN stored in user database 108. If the Virtual PIN entered by user 60 matches the user's Virtual PIN stored in user database 108 then control is passed to block 608 where social site module 1600 comprises code to set identity variable 124 of user 60 to the Virtual ID. If the

Virtual PIN entered by user 60 does not match the user's Virtual PIN stored in user database 108 then control is passed to block 204 where the system waits for user 60 to input a request for an action. All other operations of social site module 1600 are the same as social site module 114.

Referring to FIG. 17, where operation of log-in and create user account module 1602 is described. Module 1602 is the same as log-in and create account module 116 except that module 1602 requires user 60 to enter a unique Virtual ID that is stored in user database 108. All other operations are the same as module 116.

The foregoing description is intended primarily for purposes of illustration. This invention may be embodied in other forms or carried out in other ways without departing from the spirit or scope of the invention.

What is claimed:

1. A system for operating a social networking site on an Internet accessible by first and second users having first and second communication devices, respectively, the system comprising:
a server machine in communication with the internet; said server machine comprising a central processing unit, a memory system, and a social site module stored on said memory system; said social site module comprising:
a first set of code configured to create an account and a Real ID for the first user;
a second set of code configured to create an identity variable for the first user and to set said identity variable to said Real ID;
a third set of code configured to create a Virtual ID for the first user;
a fourth set of code configured to display a web page on the first communication device of the first user; said web page comprising a change identity mode button and a post by the second user;
a fifth set of code configured to change said identity variable of the first user from said Real ID to said Virtual ID upon activation of said change identity mode button; and
a sixth set of code configured to post a comment by the first user on said post by the second user displaying said Virtual ID of the first user.

2. The system of claim 1, wherein said third set of code comprises a set of code configured to randomly create said Virtual ID.

3. The system of claim 1, wherein said sixth set of code comprises a set of code configured to display said web page in a first color when said identity variable is set to Real ID.

4. The system of claim 3, wherein said sixth set of code comprises a set of code configured to display said web page in a second color when said identity variable is set to Virtual ID.

5. A method of operating a social networking site on an Internet accessible by first and second users having first and second communication devices, respectively, the method comprising the steps of:
creating an account and a Real ID for the first user;
creating an identity variable for the first user;
setting said identity variable to said Real ID;
creating a Virtual ID for the first user;
displaying a web page on the first communication device of the first user comprising a change identity mode button and a post by the second user;
changing said identity variable of the first user from said Real ID to said Virtual ID upon activation of said change identity mode button; and
posting a comment by the first user on said post by the second user displaying said Virtual ID of the first user.

6. The method of claim 5, wherein said step of creating a Virtual ID for the first user further comprises the step of randomly creating said Virtual ID.

7. The method of claim 6, wherein said step of posting a comment by the first user on said post by the second user displaying said Virtual ID of the first user further comprises the step of displaying said web page in a first color when said identity variable is set to Real ID.

8. The method of claim 8, wherein said step of posting a comment by the first user on said post by the second user displaying said Virtual ID of the first user further comprises the step of displaying said web page in a second color when said identity variable is set to Virtual ID.
